(19) United States
(12) Patent Application Publication
(10) Pub. No.: US 2003/0033035 A1
(43) Pub. Date: Feb. 13, 2003

(54) Versatile counting-meter

(76) Inventor: Mar-Tin Mar, Taipei Hsien (TW)

Correspondence Address: DOUGHERTY & TROXELL, SUITE 1404, 5205 LEESBURG PIKE, FALLS CHURCH, VA, 22041, US

(21) Appl. No.: 09/923,451

(22) Filed: Aug. 8, 2001

(51) Int. Cl. G05B 11/01; G06F 17/00; G07B 17/02

(52) U.S. Cl. 700/78; 700/12; 700/13; 700/14; 700/15

(57) ABSTRACT

A versatile counting-meter is adapted for use in cycling, jogging and treading on a mini-step, for counting exact exercise amount. The counting-meter includes a casing in which an electronic circuit for a microprocessor and a swing-link counting means for pedometer function is provided. Control keys for selecting a desired function and an LCD for showing counting result are provided at a front surface of the casing. The casing is also provided at a rear surface with a connecting means including an elastic clip located between two parallel rails. The clip is normally pulled by a restoring force thereof to flatly locate in a recess between the rails, so that the casing could be attached to a mating member mounted on a bicycle handlebar or a mini-step by engaging the rails with channels on the mating member, or to a user's belt by clamping the elastic clip onto the belt.

### BACKGROUND OF THE INVENTION

The present invention relates to a versatile counting-meter, and more particularly to a counting-meter being provided at a rear surface with a connecting means including an elastic clip normally flatly located between two parallel rails, and in an internal space with circuits for three different counting modes, so that only one single counting-meter could be selectively used in cycling, jogging and treading for counting purpose.

There are many kinds of exercises and sports for bodybuilding and fitness purpose, such as various ball games, cycling, walking, running, as well as many indoor exercises done through different sporting equipment. Currently, outdoor cycling and jogging/walking, and indoor treading on a treading machine are three most popular exercises, because they do not require specific ground, equipment, players, and/or skill to do them. In the case of the treading machine, it is simple, low cost, compact, and easy for storage when it is not in use. Further, exercisers may discretionally select a speed for themselves in doing these exercises.

There are counting-meters developed for exercisers, particularly joggers and cyclists, to easily check their exercise amount. However, such counting-meters are usually respectively designed for use in only one single type of exercise. For example, a cyclo computer is developed particularly for counting distance and speed in cycling, and a pedometer is particularly for counting number of steps in jogging and/or walking. These counting-meters generally include a casing of a suitable size, in which related circuits and components are provided to enable the counting operation. The casing is also provided at a front surface with control keys and an LCD screen, and at a rear surface with a connecting means for connecting the counting-meters to a bicycle handlebar or a user's belt. These conventional counting-meters have the following disadvantages in use:

1. Since cycling, jogging/walking and treading are presently three most popular exercises among people, it is very possible that people want to do all these three exercises separately or sequentially. Thus, for the purpose of counting the exercise amounts of different exercises, the exerciser needs to use a counting-meter for respective exercises. Wherein, there has not been developed a counting-meter for the treading exercise on an indoor treading machine.

2. When the exerciser wants to do two different exercises alternately, for example, to ride a bicycle first and then jog, he or she needs to prepare a cyclo computer and a pedometer for use in two different exercises. It is inconvenient for the exerciser to change the counting-meter from one to another during taking the exercises, and it would cost the exerciser more money to buy two counting-meters that actually have similar functions.

3. There are manufacturers who use the counting-meters as means to promote the sale of bicycles and small-scaled treading machines that are usually referred to as mini-steps. Since there is not a counting-meter that is adapted for use with a bicycle, a mini-step and a user's belt, the manufacturers have to spend more money to prepare different count-meters separately for use with the bicycle, the mini-step and the user's belt. The increased cost of the promotion means is obviously disadvantageous for both manufacturers and consumers.

In view that there is a high demand for counting-meters as the promotion means in selling sporting goods, and that the techniques for designing circuits for such counting-meters have been well developed, and that electronic components for such counting-meters, such as microprocessors, circuit boards, swing-link counting means for pedometers, and magnetic sensing means for cyclo computers, all could be massively produced to lower the costs thereof, it is therefore tried by the inventor to develop a versatile count-meter that could be supplied at reduced cost for use in all three exercises of jogging/walking, cycling, and treading for counting purpose, so that users could be saved from the trouble of buying and changing different counting-meters for different exercises.

### SUMMARY OF THE INVENTION

A primary object of the present invention is to provide a versatile counting-meter designed for use in three most popular exercises, namely, cycling, jogging and treading on a mini-step, for selectively counting numbers of steps, wheel rotations, and treads. The counting-meter includes a casing having an electronic circuit for a microprocessor and a swing-link counting means for pedometer function provided therein, and control keys for selecting one of three desired functions and an LCD screen for showing number of counts provided at a front surface of the casing. The casing is also provided at a rear surface with a connecting means including an elastic clip located between two parallel rails. The clip is normally pulled by a restoring force thereof to flatly locate in a recess between the rails, so that the casing could be attached to a mating member mounted on a bicycle handlebar or a mini-step by engaging the rails with channels on the mating member, or to a user's belt by clamping the elastic clip onto the belt. Thereby, only one counting-meter could be conveniently and economically used in three different exercises.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled front perspective view of a versatile counting-meter according to the present invention;

FIG. 2 is an exploded rear perspective view of the versatile counting-meter of FIG. 1;

FIG. 3 shows the versatile counting-meter of the present invention is attached to a user's belt for counting the number of steps of the user during running, jogging or walking;

FIG. 4 shows a bicycle to which the versatile counting-meter of the present invention may be attached for counting the rotational speed and/or number of rotations of a wheel during cycling;

FIG. 5 is a fragmentary, enlarged and exploded perspective view of FIG. 4;

FIG. 6 shows a mini-step to which the versatile counting-meter of the present invention may be attached for counting the number of treads during a treading exercise;

FIG. 7 is a fragmentary, enlarged and exploded perspective view of FIG. 6;

FIG. 8 is a block diagram showing the structural relation of different elements of the present invention with one another;

FIG. 9 is a flowchart showing the operations of the present invention; and

FIG. 10 shows an embodiment of a screen of the liquid crystal display (LCD) included in the present invention.

### DETAILED DESCRIPTION OF THE PREFERRED EMBODIMENTS

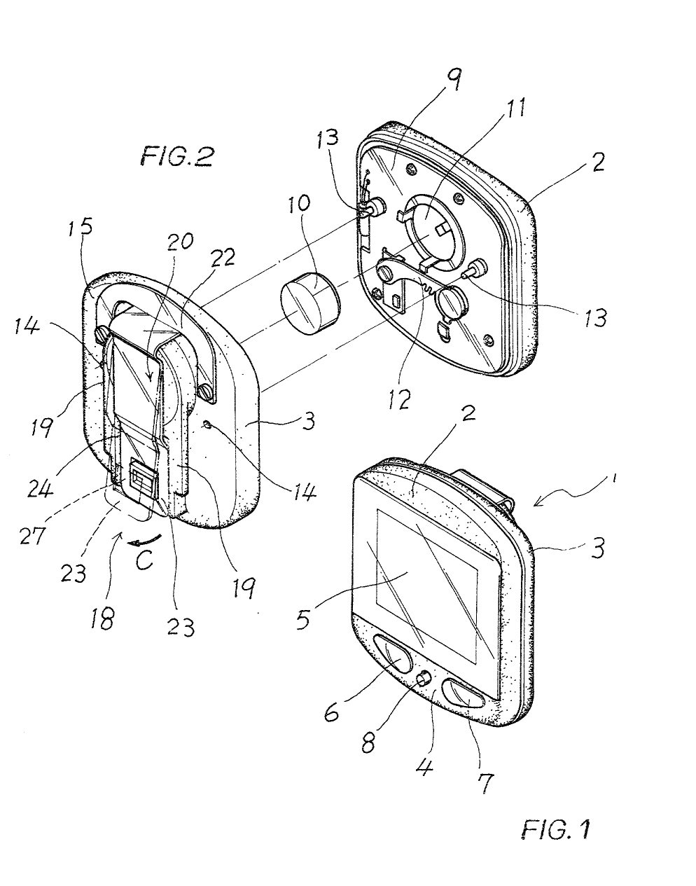

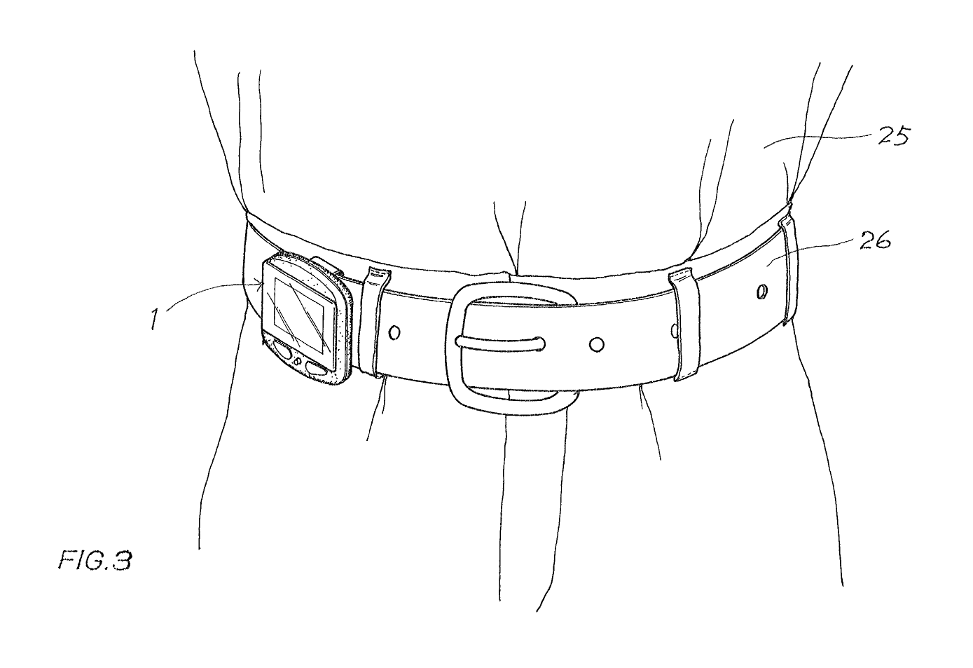

Please refer to FIGS. 1 and 2 that are assembled and exploded perspective views, respectively, of a versatile counting-meter according to the present invention. A main body 1 of the versatile counting-meter of the present invention is a casing made of a rigid plastic material, and includes a front case 2 and a rear case 3 that are closed to each other. The main body 1 is provided at a front surface 4 with a liquid crystal display (LCD) screen 5, a key for sensor switching 6, a key for operating 7, an ON/OFF button 8, etc. The front case 2 is internally provided with a circuit board 9. There is a space between a front side of the circuit board 9 and the front case 2 forming a chamber for accommodating related electronic components (not shown). The circuit board 9 is provided at a rear side with a battery holder 11 for holding a mercury battery 10, a swing-link counting means 12 for counting steps, and two laterally spaced metal bars 13. The two metal bars 13 rearward extend from the circuit board 9 through two corresponding holes 14 on the rear case 3, so that free ends of the metal bars 13 are exposed from a rear surface 15 of the main body 1.

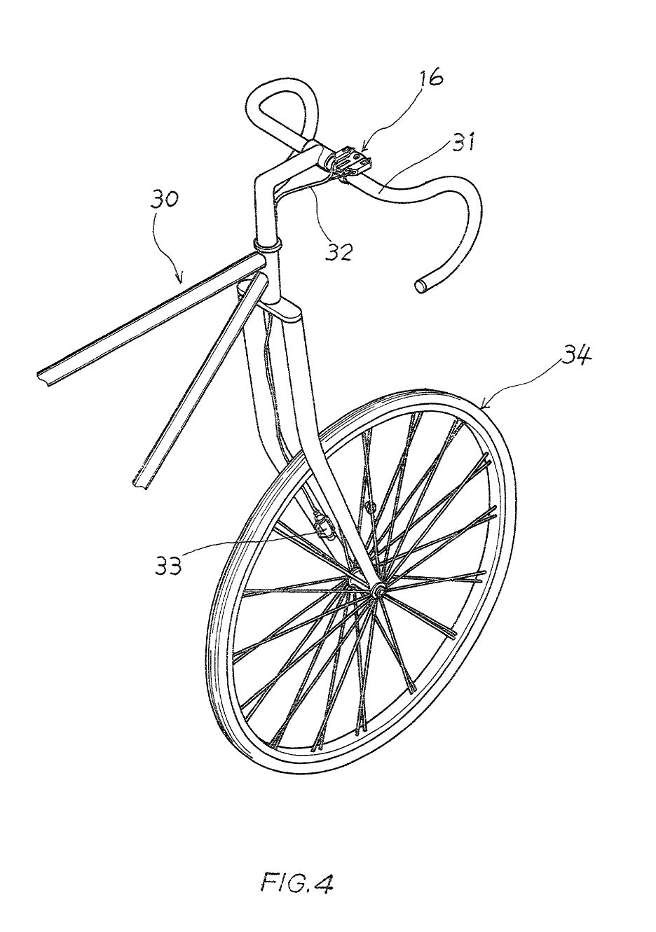

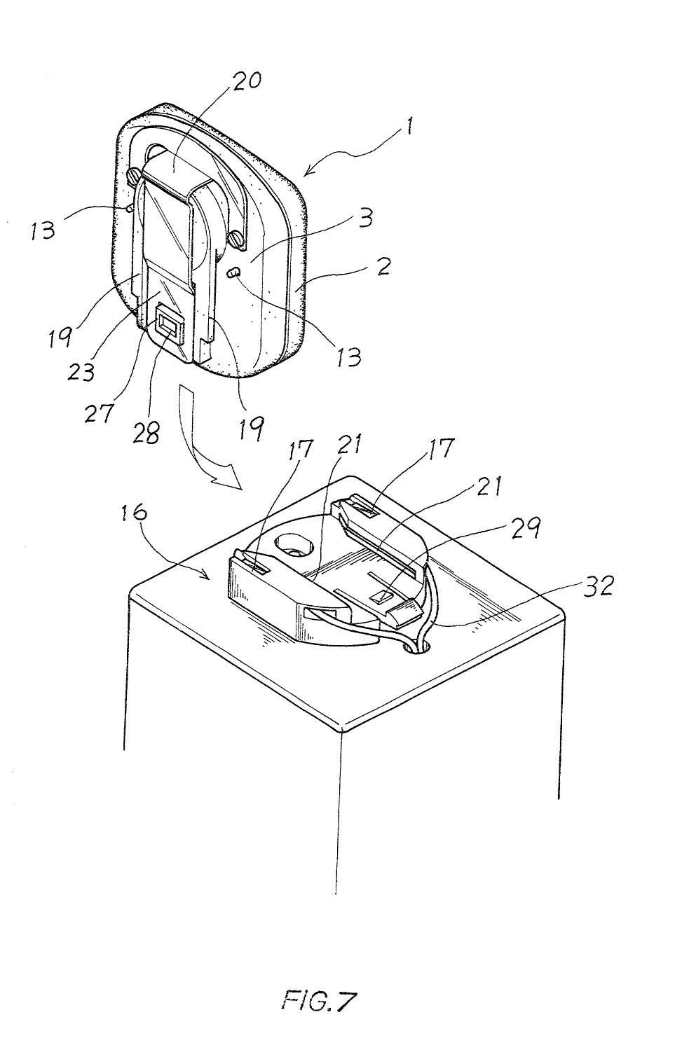

The versatile counting-meter of the present invention is characterized in that the rear surface 15 of the main body 1 is provided at a predetermined position, preferably a central area thereof, with a connecting means 18 that includes two laterally symmetrically spaced parallel rails 19 and a clip 20. The rails 19 may be those usually provided on the conventional counting-meter, so that they could be slid into two corresponding channels 21 on a mating member 16 of the versatile counting-meter of the present invention to hold the counting-meter in place on the mating member 16 (see FIGS. 5 and 7). The clip 20 is an elastic plate providing sufficient elastic restoring force. The clip 20 is screwed at an upper end 22 to an upper part of the rear surface 15 of the rear case 3 between upper ends of the two parallel rails 19, so that a lower free end 23 of the clip 20 is normally pulled by its restoring force to flatly locate in a recess 24 provided on the rear surface 15 between lower parts of the two rails 19 and could be elastically and pivotally pulled outward with an external force, as indicated by the arrow C in FIG. 2. When the counting-meter of the present invention functions like a pedometer, the elastic clip 20 allows the counting-meter of the present invention to be conveniently clamped onto a user's belt 26 when the user 25 is jogging, running or walking, as shown in FIG. 3. When the counting-meter of the present invention is not in the state of being clamped onto the belt 26, the elastic restoring force of the clip 20 enables the lower free end 23 of the clip 20 to fitly fall into the recess 24, allowing the two rails 19 to slide into the corresponding channels 21 on the mating member 16, as shown in FIGS. 5 and 7. The lower free end 23 of the clip 20 is provided with a hole 27, via which a raised retaining socket 28 correspondingly provided on the recess 24 projects. The mating member 16 is provided at a predetermined position with a retaining key 29 corresponding to the retaining socket 28 on the counting-meter. Whereby, when the main body 1 of the counting-meter of the present invention is attached to the mating member 16 by engaging the two rails 19 with the two channels 21, the retaining socket 28 engages with the retaining key 29 to firmly hold the counting-meter to the mating member 16. The mating member 16 is also provided at predetermined positions with two conductive strips 17, so that the metal bars 13 exposed from the rear surface 15 of the main body 1 electrically contact with the conducting strips 17 when the counting-meter is firmly attached to the mating member 16.

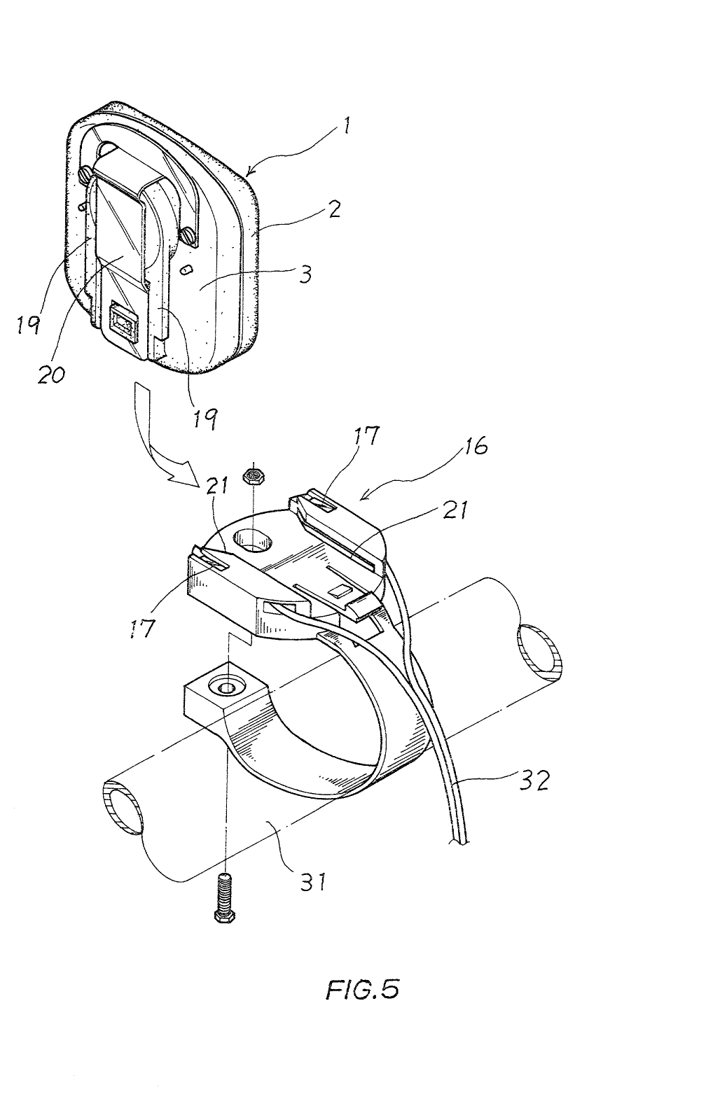

Please refer to FIGS. 4 and 5. The versatile counting-meter of the present invention may be mounted onto a bicycle 30 to function like a cyclo computer for counting the number of rotations or the rotational speed of a wheel 34 of the bicycle 30 when the user 25 rides the bicycle 30. To do so, the mating member 16 is screwed to a handlebar 31 of the bicycle 30. The user 25 may remove the counting-meter from the belt 26 and operates the key for sensor switching 6 and the key for operating 7 to switch and set the main body 1 to a cyclo-computer function that would be described in more details later, and then slide the rails 19 into the channels 21 on the mating member 16. The two conductive strips 17 on the mating member 16 are electrically connected via conductors 32 to a magnetic sensor 33 mounted on the wheel 34. Signals of wheel rotations are sent by the magnetic sensor 33 to the main body 1 of the counting-meter and are converted into number of wheel rotation counts and displayed at the LCD screen 5. Since the magnetic sensor 33 is a technique known in the art, it is not discussed in details herein.

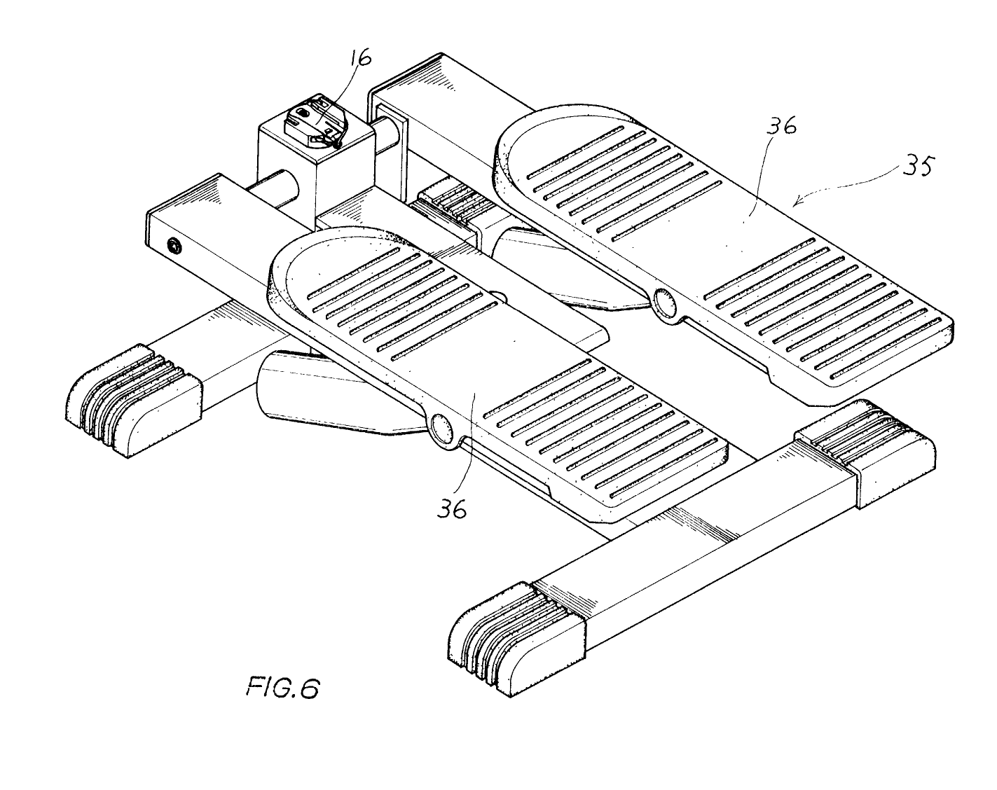

FIG. 6 shows a mini-step 35 that is one of the most popular small-scale sporting goods available in the markets. A user may alternately tread on two pedals 36 of the mini-step 35 to achieve the same effect of walking on the ground. The counting-meter of the present invention may also function like a tread counter. In this case, the user 25 may remove the counting-meter 1 from the belt 26 in FIG. 3 or the bicycle 30 in FIG. 5 and operates the key for sensor switching 6 and the key for operating 7 to switch and set the main body 1 to a tread counting function, and then attaches the counting-meter 1 to the mating member 16 that has previously been mounted on the mini-step 35 at a predetermined position. The two conductive strips 17 on the mating member 16 are electrically connected via conductors 32 to a magnetic sensor 33 mounted on one of the two pedals 36. Whereby, when the pedals 36 are alternately trod to reciprocatingly move up and down, signals are produced and sent by the magnetic sensor 33 to the main body 1 of the counting-meter and converted into number of tread counts and displayed at the LCD screen 5.

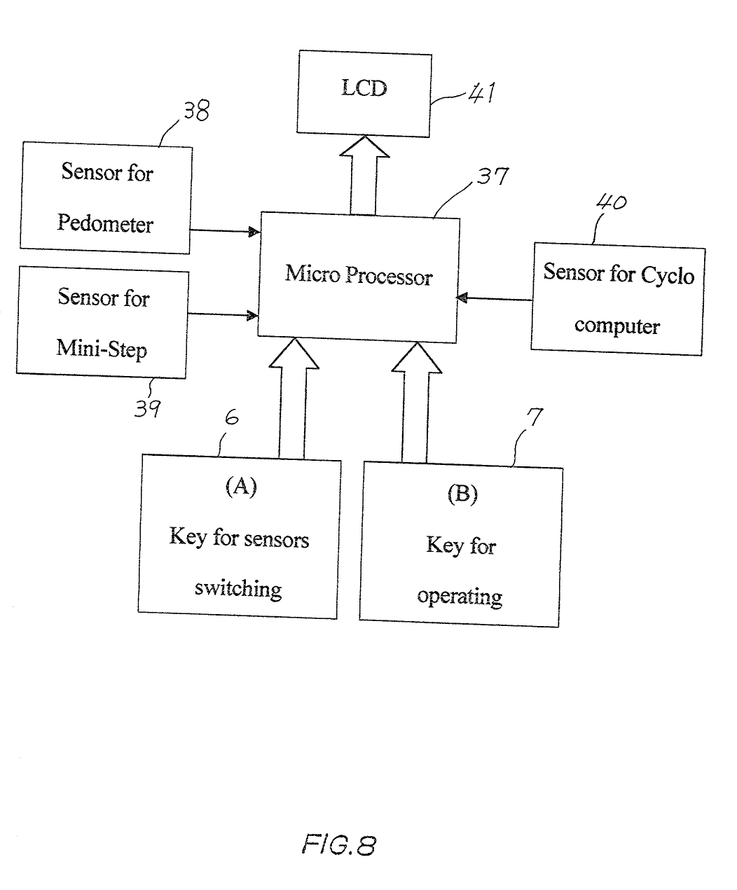

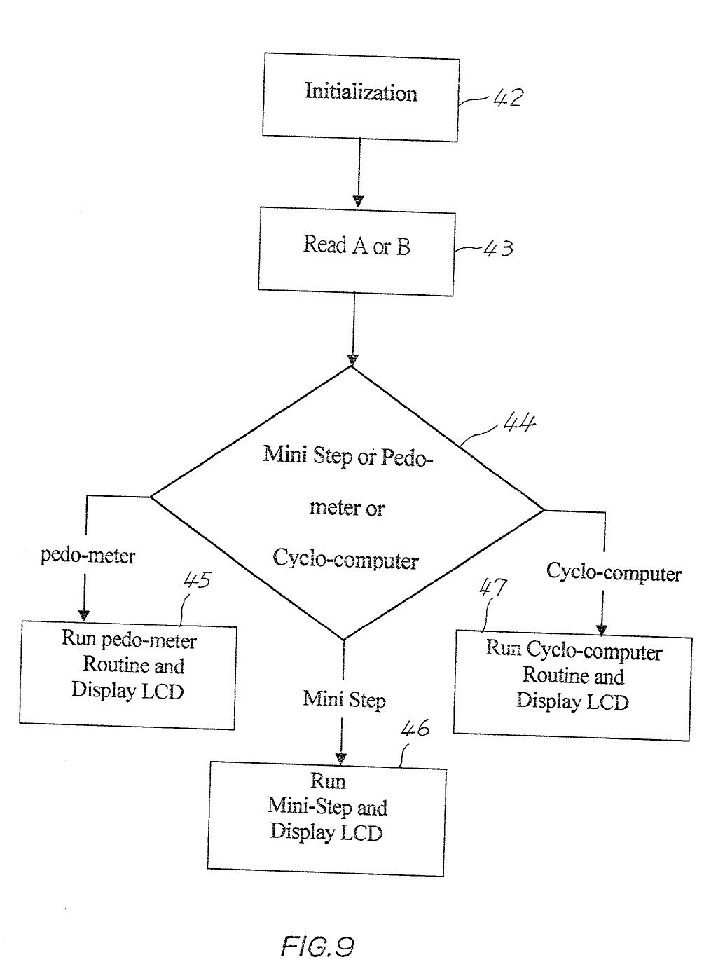

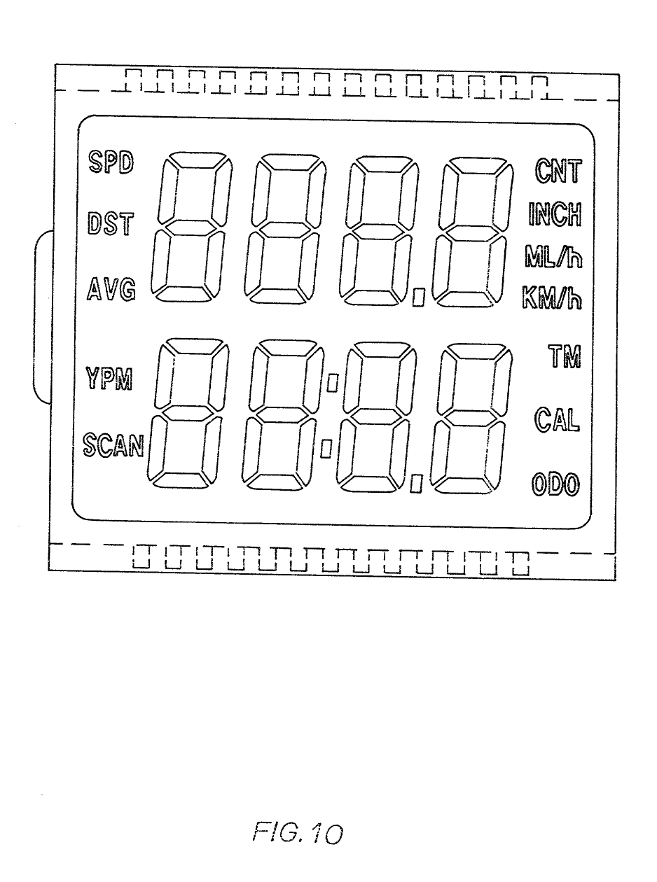

With the currently available electronic technologies, it is possible to design a circuit for implementing the versatile counting-meter of the present invention. The circuitry and the operational steps of the present invention are now described with reference to FIGS. 8 and 9.

Please refer to FIG. 8. The circuitry of the versatile counting-meter of the present invention mainly includes a microprocessor 37 having a sensor for pedometer 38, a sensor for mini-step 39, and a sensor for cyclo computer 40 connected thereto. The sensor for pedometer 38 employs the above-mentioned swing-link counting means 12 to achieve the sensing function. That is, a swing link in the swing-link counting means 12 swings when the user 25 runs, jogs or walks and sends out signals to the microprocessor 37. On the other hand, the sensors for the mini-step and the cyclo computer 39, 40 employ the above-mentioned magnetic sensors 33 to achieve the sensing function. The microprocessor 37 is also connected to the key for sensor switching 6 and the key for operating 7 for the user to select operations of one of the sensors 38, 39 and 40 for counting purpose. The number of counts is displayed at the screen 5 of the LCD 41. FIG. 10 shows an embodiment of the LCD screen 5. Classifications of data shown on the LCD screen 5, such as SPD (speed), DST (distance), AVG (average), etc., are designed depending on the structure of the microprocessor 37.

FIG. 9 is a flowchart showing operating steps of the versatile counting-meter of the present invention. The counting-meter is subject to a series of initialization procedures (step 42) when the ON/OFF key 8 is initially depressed or the counting-meter is initially in a certain operating mode and is changed over to another mode. Then, signal A or B is read or received (step 43). Wherein, signal A is a signal produced by operating of the key for sensor switching 6, and signal B is a signal produced by operating the key for operating 7. Depending on the signal A or B read or received, one of the pedometer function, the mini-step tread-counter function, and the cyclo-computer function is selected (step 44), and the counting-meter enters either the pedometer mode (step 45), the mini-step tread-counter mode (step 46), or the cyclo-computer mode (step 47). And, the number of counts obtained in each operating mode 45, 46 or 47 is shown at the LCD screen 5 to complete the entire operational procedures. The versatile counting-meter of the present invention then returns to the Initialization step 42 and is ready for setting next time.

What is claimed is:

1. A versatile counting-meter, comprising a main body in the form of a casing, said casing being provided at a front surface with at least a liquid crystal display (LCD) screen, a key for sensor switching, a key for operating, and an ON/OFF button, and in an internal space thereof with an electronic circuit for a microprocessor, a swing-link counting means for implementing a pedometer function, and two laterally spaced metal bars having free ends exposed from a rear surface of said casing to serve as two electrically conductive contacts; said counting-meter being characterized in that said casing is provided at said rear surface with a connecting means including two laterally and symmetrically spaced parallel rails and a clip, said clip being an elastic plate providing sufficient elastic restoring force and screwed at an upper end to an upper part of said rear surface of said casing between two upper ends of said two rails, such that a lower free end of said clip is located in a recess provided on said rear surface between two lower ends of said two rails; and said lower free end of said clip being elastically outward turnable for firmly clamping said casing to a user's belt due to said elastic restoring force provided by said clip.

2. The versatile counting-meter as claimed in claim 1, wherein said lower free end of said clip is normally pulled by said elastic restoring force of said clip inward to flatly locate in said recess on said rear surface of said casing.

3. The versatile counting-meter as claimed in claim 1, wherein said lower free end of said clip is provided at a predetermined position with a hole, and said recess on said rear surface of said casing being provided with a raised retaining socket corresponding to said hole on said clip so as to project from said hole when said clip is flatly located in said recess.
